(19) United States
(12) Patent Application Publication
(10) Pub. No.: US 2013/0060760 A1
(43) Pub. Date: Mar. 7, 2013

(54) DETERMINING COMPREHENSIVE SUBSETS OF REVIEWS

(71) Applicants: Panayiotis Tsaparas, San Francisco, WA (US); Alexandros Ntoulas, San Francisco, CA (US); Evimaria Terzi, Cambridge, MA (US)

(72) Inventors: Panayiotis Tsaparas, San Francisco, WA (US); Alexandros Ntoulas, San Francisco, CA (US); Evimaria Terzi, Cambridge, MA (US)

(73) Assignee: Microsoft Corporation, Redmond, WA (US)

(21) Appl. No.: 13/224,350

(22) Filed: Sep. 2, 2011

(51) Int. Cl. G06F 17/30

(52) U.S. Cl. 707/723; 707/E17.005

(57) ABSTRACT

Techniques are provided for selecting a limited but comprehensive set of high-quality users reviews covering several different aspects or attributes of a reviewed item. For several implementations, selection methodologies approach the challenge as a maximum coverage problem and provide a generic formalism to model the different variants of the review-set selection. Variations to such implementation may also employ different algorithms in consideration of different variants and weightings of those variants. Select implementations employ methodologies that collectively consider attributes of the item discussed in the reviews, the quality of the reviews themselves, and the viewpoint of the reviews (e.g., positive or negative) as input values in order to provide outputs that cover as many attributes of the item as possible, comprising high quality reviews representing different viewpoints.

### BACKGROUND

Online user reviews have become an invaluable resource for consumers making informed decisions for a variety of activities such as purchasing products, booking flights and hotels, selecting restaurants, or picking movies to see. Several websites have become viable businesses as user review portals, while other businesses can attribute at least part of their success to consumers' use of extensive reviews found on their website. In general, consumers find user reviews to be beneficial in that they are voluminous, comprehensive, and collectively provide a picture that is rich in detail and diverse in perspective.

However, the abundance of information available in the form of user reviews can be overwhelming to online users. Popular products often have several hundred reviews, and many of these may be fraudulent, uninformative, or repetitive. One approach to addressing this problem is to allow users to rate reviews according to their helpfulness. However, these approaches do not account for the redundancy in the content of the reviews, cannot ensure that all important aspects of the reviewed item are covered by the results presented, and do not necessarily represent all different viewpoints.

In view of these shortcomings, the need for both compact and comprehensive user reviews is becoming increasingly apparent, and nowhere is this need most keenly felt than by users of mobile smartphones and other portable devices. Since screen size and time resources are more limited, users of these portable devices often need access to helpful and high-quality information quickly and easily in order to make immediate decisions without being able to afford themselves the luxury of carefully going through multiple reviews. However, current user review resources cannot effectively address these needs.

### SUMMARY

A comprehensive set of relatively few high-quality users reviews of a reviewed item are selected that cover several different aspects or attributes of the reviewed item.

In some implementations, selection methodologies are directed to a maximum coverage problem and provide a generic formalism to model the different variants of the review-set selection. Certain variations of such implementations may employ different algorithms in consideration of different variants and weightings of those variants.

In some implementations, methodologies may be used that collectively consider attributes of the item discussed in the reviews, the quality of the reviews themselves, and the viewpoint of the reviews (e.g., positive or negative) as input values in order to provide outputs that cover as many attributes of the item as possible, comprising high quality reviews representing different viewpoints.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

To facilitate an understanding of and for the purpose of illustrating the present disclosure and various implementations, exemplary features and implementations are disclosed in, and are better understood when read in conjunction with, the accompanying drawings—it being understood, however, that the present disclosure is not limited to the specific methods, precise arrangements, and instrumentalities disclosed. Similar reference characters denote similar elements throughout the several views. In the drawings:

FIG. 1 is an illustration of an exemplary network environment in which the numerous implementations disclosed herein may be utilized;

FIG. 2 is an illustration of an example user reviews section from a website to which various implementations disclosed herein may be utilized;

FIG. 3 is a process flow diagram for an exemplary greedy algorithm that may be utilized by several implementations disclosed herein;

FIG. 4 is a process flow diagram for an exemplary t-greedy algorithm that may be utilized by select implementations disclosed herein employing a group-coverage function;

FIG. 5 is a process block diagram illustrating utilization of the various coverage functions herein described that may be utilized by various implementations; and

FIG. 6 is a block diagram representing an exemplary computing environment.

### DETAILED DESCRIPTION

Disclosed herein are various implementations for selecting a small comprehensive set of user reviews from of a large set of reviews for a given item such that the selected set covers as many aspects and attributes of the product as possible with high-quality reviews from diverse viewpoints.

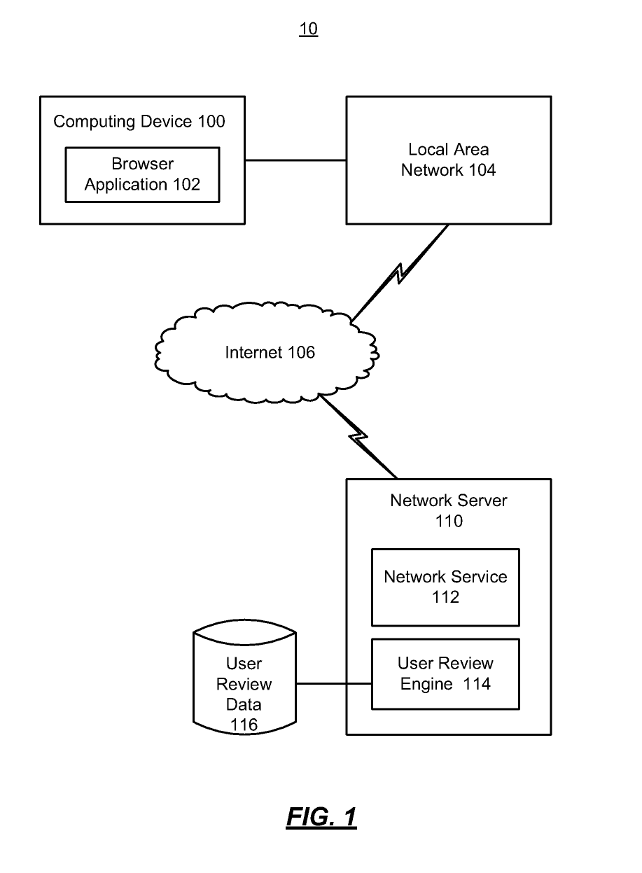

FIG. 1 is an illustration of an exemplary network environment 10 in which numerous implementations disclosed herein may be utilized. In the figure, a computing device 100 includes a network interface (not shown) facilitating communications over a communications medium. The computing device 100 may communicate with a network 104 via a physical connection, for example. Alternatively, the computing device 100 may communicate with the network 104 via a wireless wide area network or a wireless local area network media, or via other communications media. The computing device 100 may be a desktop personal computer, workstation, laptop, PDA, cell phone, smart phone, or any WAP-enabled device or any other computing device capable of interfacing directly or indirectly with the network 104 such as a computing device 600 illustrated in FIG. 6.

A user of the computing device 100, as a result of the supported network medium, is able to access network resources typically through the use of a browser application 102 running on the computing device 100. The browser application 102 facilitates communication with a remote network over, for example, the Internet 106 which in turn may facilitate communication with a network service 112 running on a network server 110. The network server 110 may further comprise a user review engine 114 for providing third party user reviews through the network service 112 to the computing device 100.

The computing device 100 may run an HTTP client (e.g., a web-browsing program such as browser application 102) or a WAP-enabled browser in the case of a cell phone, PDA or other wireless device, or the like, allowing a user of the computing device to access information available to it on the network server 110 or to provide information to the network server 110. Other applications may also be used by the computing device 100 to access or provide information to the network service 112 or the user review engine 114, for example. In some implementations, the network server 110 may be implemented using one or more general purpose computing systems such as the computing device 600 illustrated in FIG. 6.

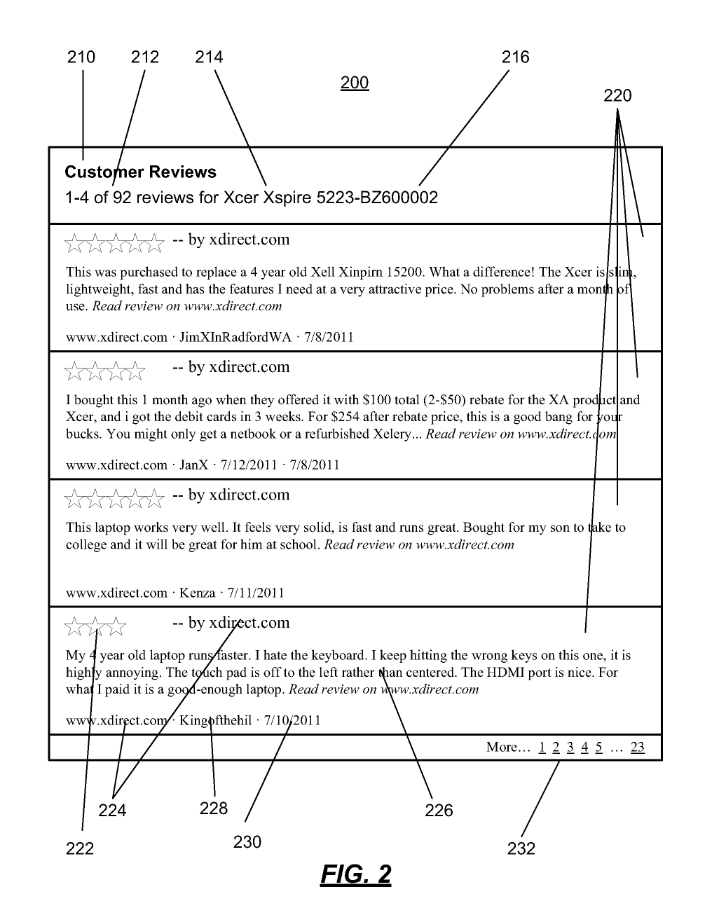

FIG. 2 is an illustration of an example user reviews section 200 for a website with which various implementations disclosed herein may be utilized. In the figure, a user reviews section 200 may comprise a page identifier or title section 210 with an indicator 212 indicating the number of reviews and the reviews being displayed, as well as an item name 214 and an item identification number 216. The individual user reviews 220 are listed and may comprise a star-rating 222 or other form of perspective (e.g., numerical, etc.), as well as the item supplier identity 224 (listed herein this example in two places per user review) since the review may discuss both the item and the item's supplier. Then, in addition to the review text 226, the user review may also include a user display name 228 and the time (not shown) and/or date 230 the date was posted. The user reviews section 200 may also include easy navigation links 232 to enable the user to more easily view additional reviews.

In order to select a small comprehensive set of user reviews from a large set of reviews for a given item such that the selected set covers as many aspects and attributes of the product as possible with high-quality reviews from diverse viewpoints, various implementations perform user review set selection employing methodologies for solving maximum coverage problems. As such, given an item (e.g., a product for sale on a website) having a set of attributes A={a₁, a₂, . . . , aₘ} and a set of reviews R={r₁, r₂, . . . , rₙ}, where each review r has a subset of attributes Aᵣ that are found in that review r. Thus, review r is said to “cover” an attribute a if that attribute is a member of the set of attributes found in r, and Rₐ denotes the set of reviews that cover attribute a from among the global set of reviews R. Similarly, S denotes a subset of these reviews R.

In view of the conventions, various implementations use a coverage scoring function ƒ(S,a) to assigns a score to an attribute a given a subset of reviews S to determine the score for (or benefit obtained from) covering the attribute a with the subset of reviews S. In addition, where Aₛ denote the union of attributes covered by the reviews in the subset of reviews S, these implementations define the function ƒ such that the function results are equal to zero, i.e., ƒ(S,a)=0, for all attributes that are not included in Aₛ, and such that determining the function ƒ for a subset of reviews S only needs to be performed to determine the value ƒ(S,a) for the attributes that comprise Aₛ (the union of attributes covered by the reviews in the subset of reviews S).

As such, given a set of attributes A, a set of reviews R, an integer budget value k representing the maximum number of user reviews comprising the results, various implementations disclosed herein determine a subset of reviews that maximizes the cumulative coverage scoring function F(S) represented by formula (1):

$$F ( S ) = {Σ}_{a ∈ A} f ( S , a ) \qquad ( 1 )$$

wherein F(S) is defined with respect to a coverage scoring function ƒ of which several variations are possible.

For several such implementations, the same score (e.g., a value of one) may be assigned to all covered attributes, in which case the coverage scoring function is a “unit-coverage function” denoted as ƒᵤ(S,a)=1 for all attributes a covered by the subset of reviews S. A greedy algorithm may then be used to select those user reviews that maximize the increase of the cumulative function F. As will be appreciated by skilled artisans, this greedy algorithm may have a constant approximation ratio with respect to an optimal solution.

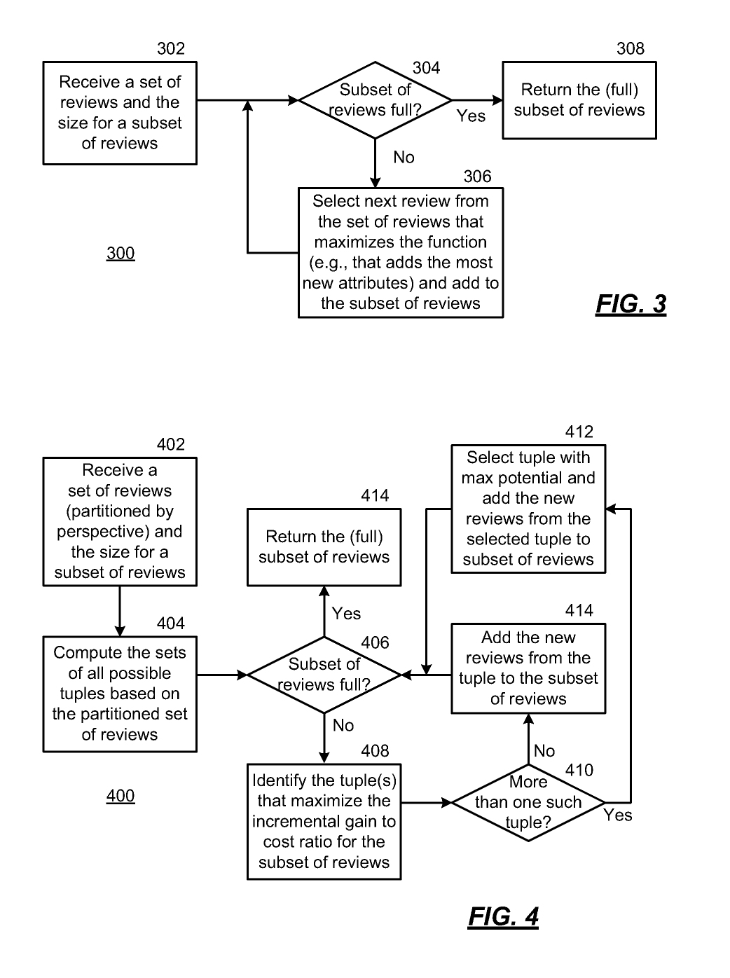

FIG. 3 is a process flow diagram 300 for an exemplary greedy algorithm that may be utilized by several implementations disclosed herein. In the diagram, the process begins at 302 by receiving as input a set of reviews R and a value k corresponding to the number of reviews that will comprise the output subset of reviews S (which, initially, is empty).

At 304, the process checks to determine if the output subset of reviews is full and, if not, then at 306 the process selects the user review r from the not-yet-selected reviews comprising R that maximizes the function F, that is, that adds the most new attributes a to the subset of reviews S. Stated differently, the process selects the user review r from the unselected set R-S that maximizes the function F(S∪{r})−F(S). The process then returns to 304 to determine if the output subset of reviews is full and recursively repeats 306 until it is. When full, at 308, the process returns the resultant subset of reviews S comprising exactly k reviews covering as many attributes a as determinable.

For several alternative implementations, the coverage scoring function ƒ might instead be configured as a “quality-coverage function” that considers a quality value q(r) where it is desirable for the resultant subset of reviews S to cover attributes a with high-quality reviews (that is, the highest-quality review in a selected set) such that the score of a covered attribute is the maximum review quality over all reviews that cover that attribute as represented by formula (2):

$${f}_{q} \{ S , a \} = {max}_{r ∈ {S}_{a}} q ( r ) \qquad ( 2 )$$

where the objective is again to maximize the cumulative scoring function F using the greedy algorithm discussed earlier herein.

For yet other alternative implementations, the coverage scoring function ƒ might instead be configured to consider the user reviews R when they can be partitioned into g disjoint groups R¹, R², . . . , R^{g} corresponding to different viewpoints on the item subject to the reviews R. Thus the reviews can be partitioned into positive/negative, 1-star to 5-stars, A+ to F, and so on and so forth accordingly. For certain such implementations, the viewpoint groups may also be customized (e.g., grouped, consolidated, expanded, weighted, etc.) to meet specific needs or purposes. Regardless, the scoring function ƒ in these implementations (referred to as the “soft-group-coverage function”) may be configured to ensure that the subset of reviews R includes reviews r from all groups g so as to cover all possible viewpoints about the item.

In one exemplary approach, the underlying algorithm might reward the various viewpoints without necessarily enforcing them by defining the scoring function as represented by formula (3):

$${f}_{s} \{ S , a \} = {\sum }_{i = 1}^{g} f ( {S}^{i} , a ) \qquad ( 3 )$$

where ƒₛ(S,a) is defined with respect to the base function ƒ which for certain implementations may be the aforementioned unit-coverage function ƒᵤ, or for certain alternative implementations may be the aforementioned quality-coverage function ƒ_{q}; and where Sⁱ denotes the subset of reviews in S that belong to the group i. Then, once again, the greedy algorithm can be utilized to maximize the cumulative scoring function F as discussed earlier herein.

For yet other select implementations, however, it may be desirable for each attribute to be covered by at least one review from each group in order to ensure that all viewpoints are represented in the resulting subset of reviews S. For these select implementations, and again using a base scoring function ƒ (e.g., either ƒᵤ or ƒₛ), the scoring function (referred to as the “group-coverage function”) can be defined as represented in formula (4):

$${f}_{g} ( S , a ) = {min}_{i = 1 …g} f ( {S}^{i} , a ) \qquad ( 4 )$$

However, unlike the other implementations disclosed herein for which a greedy algorithm could be used, it is not straightforward to use the previously described greedy algorithm because of the inherent constraints of multiple coverage (since the process cannot select one review at a time); that is, a single review does not alone provide benefit since it cannot alone meet the requirements for any attributes.

Consequently, such group-coverage function instead processes tuples of reviews for all possible tuples where each tuple is a cross-product of all review groups, i.e., where all possible tuples T=R¹×R²× . . . ×R^{g}. As such, the process then defines the set of attributes covered by the tuple (equal to all of the attributes covered by all the members of the tuple). Moreover, the score of the attribute is the minimum over all reviews of the quality of the review. With these tuples, then, a tuple-based greedy algorithm (referred to as the “t-greedy algorithm”) may be employed.

For the t-greedy algorithm, three measures are defined. First, the incremental gain is denoted by Δₛ(t)=F(S∪{t})−F(S). Second, the cost of the tuple, that is, the number of new reviews in tuple t that are not in set S, is denoted by Cₛ(t)=|t−S|. Third, the potential of a tuple t, that is, the number of attributes that are not covered by either the set S or the tuple t but that appear in at least one of the reviews of tuple t, is denoted by Pₛ(t). However, as will be appreciated by skilled artisans, this t-greedy algorithm, unlike the greedy algorithm, will not necessarily have a constant approximation ratio with respect to an optimal solution.

FIG. 4 is a process flow diagram 400 for an exemplary t-greedy algorithm that may be utilized by select implementations disclosed herein employing a group-coverage function. In the diagram, the process begins at 402 by receiving as inputs (a) a set of reviews R partitioned into g groups R¹, R², . . . , R^{g}; and (b) a value k corresponding to the number of reviews that will comprise the output subset of reviews S (which, initially, is empty).

At 404, the process computes the set of tuples T=R¹×R²× . . . ×R^{g}. Then, at 406, the process checks to determine if the output subset of reviews S is full. If not, then at 408 the process recursively continues with identifying the tuple(s) t from all possible tuples T that maximize(s) the value of the incremental gain to cost ratio represented by formula (5):

$$\frac{{Δ}_{S} ( t )}{{C}_{S} ( t )} \qquad ( 5 )$$

At 410, a check is then made to see if more than one tuple was identified at 408. If so, then the tuple with the maximum potential Pₛ(t) is determined and selected at 412 such that the “new reviews” (that is, those not already a member of S) are added to S. If not, then the sole tuple identified at 408 is selected and its new reviews are added to S. The process then repeatedly returns to 406 until the set S is filled, at which point, at 414, the process then returns the resultant subset of review S comprising exactly k reviews.

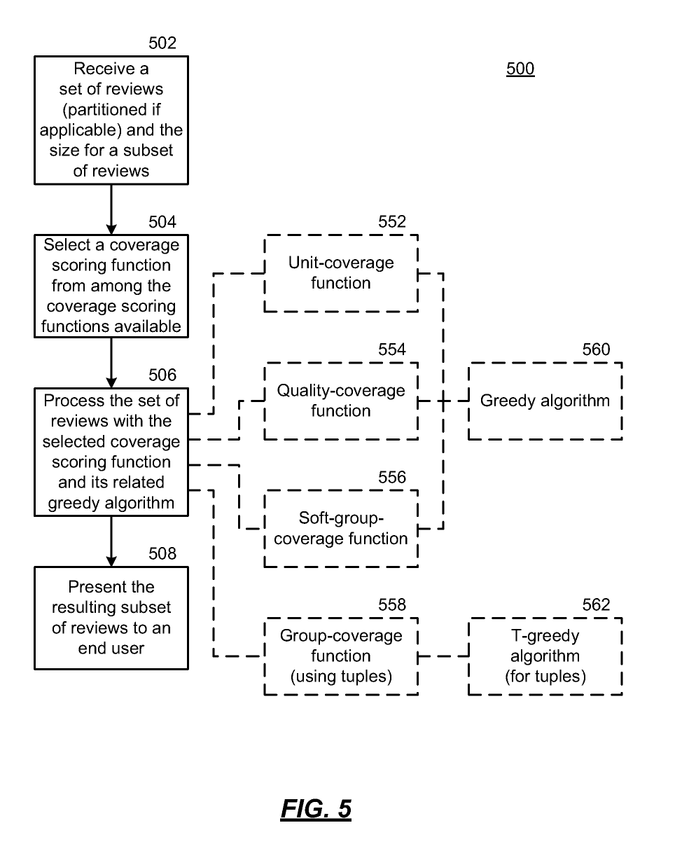

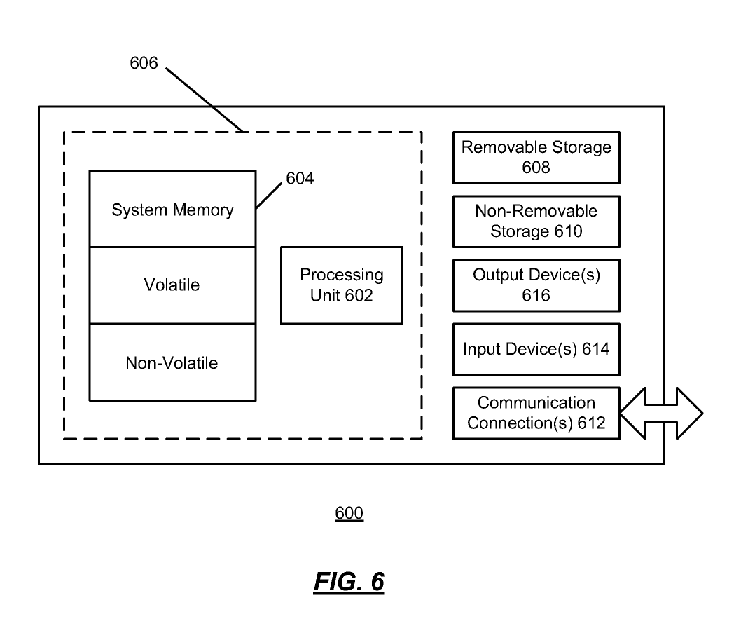

FIG. 5 is a process block diagram illustrating utilization of the various coverage functions herein described that may be utilized by various implementations. In the figure, a method 500 for selecting a subset of reviews from a plurality of reviews begins at 502 with receiving a set of reviews R (partitioned into g groups R¹, R², . . . , R^{g} if necessary for the soft-group-coverage function or group-coverage function) and a value k corresponding to the number of reviews to comprise a resulting subset of reviews S.

At 504, a coverage scoring function ƒ(S,a) is selected from among the available coverage functions and, at 506, the set of reviews is processed with the selected coverage scoring function and its related (or corresponding) greedy algorithm. As disclosed earlier herein, the coverage scoring function may be a unit-coverage function 552, a quality-coverage function 554, a soft-group-coverage function 556, or a group-coverage function 558, where the first three may utilize the greedy algorithm 560 while the last (being tuple-based) may use the special t-greedy algorithm 562. Once processing is complete, then at 508 the resulting set of reviews may be presented to the end user.

Although the implementations so far described herein select as small set of reviews of fixed size k that cover as many attributes as possible, alternative implementations may select the smallest subset of reviews that cover all attributes (without regard to preset size requirement). For certain such implementations, the greedy algorithm described herein may also be applied. Similarly, while the foregoing implementations described herein considered attributes that were statically prespecified, other alternative implementations may use attributes that may be dynamically specified by a user at query time, and/or select the size k of the results to be returned as well as the base function corresponding to the selection methodology. For certain such implementations, the attributes might also comprise query terms rather than predetermined attributes.

In addition, certain alternative implementations may address the situation where reviews belong to more than one group, or that the group may change based on a specific attribute in focus. For example, a review may be positive about one attribute, and negative about another, and thus implementations extend to such cases. Using the soft-group algorithm, the extension is straightforward, and for the t-greedy algorithm each attribute could define the set of all tuples that cover the attribute from all different groups and then proceed in the same fashion as previously described (i.e., selecting tuples greedily). Lastly, certain other alternative implementation may use attributes that have an importance weight such that one attribute is more important than another, in which some such implementations may incorporate attribute importance by, for example, multiplying the score of an attribute by its attribute importance. Moreover, in the case of dynamic attributes, the attribute weight may be defined by the user.

The various implementations herein disclosed may be applied to multiple domains beyond online shopping but to any type of commercial or non-commercial situation where third-party opinions are considered valuable to other parties, as well as readily apparent applications to news articles, and social networks covering different aspects of an event or a person, with high-quality content and diverse viewpoints. To this extent, the term “review” as used herein is intended to cover all possible variations and utilizations of the techniques disclosed herein with regard to such other domains.

FIG. 6 shows an exemplary computing environment in which example implementations and aspects may be implemented. The computing system environment is only one example of a suitable computing environment and is not intended to suggest any limitation as to the scope of use or functionality. Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for selecting a subset of reviews from a plurality of reviews, the method comprising:
selecting a predetermined number of reviews from among the plurality of reviews wherein the selected reviews maximize coverage of a plurality of attributes; and
presenting the subset of reviews to a computing device of a user.

2. The method of claim 1, wherein the selecting is performed using a cumulative coverage scoring function defined with respect to a unit-coverage function and that utilizes a greedy algorithm.

3. The method of claim 1, wherein the selected reviews comprise the highest-quality review in a selected set for each attribute comprising the plurality of attributes covered by the selected reviews.

4. The method of claim 3, wherein the selecting is performed using a cumulative coverage scoring function defined with respect to a quality-coverage function that utilizes a greedy algorithm.

5. The method of claim 3, wherein the selected reviews comprise user reviews for each viewpoint from among a plurality of viewpoints.

6. The method of claim 5, wherein the selecting is performed using a cumulative coverage scoring function defined with respect to a soft-group-coverage function that utilizes a greedy algorithm.

7. The method of claim 6, wherein the soft-group-coverage function is further defined by a base function corresponding to either a unit-coverage function or a quality-coverage function.

8. The method of claim 5, wherein the selected reviews further comprise user reviews for each viewpoint from among a plurality of viewpoints for each attribute covered by the selected reviews.

9. The method of claim 8, wherein the selecting is performed using a cumulative coverage scoring function defined with respect to a group-coverage function that utilizes a t-greedy algorithm to process a plurality of tuples each comprising a plurality of reviews.

10. The method of claim 9, wherein the group-coverage function is further defined by a base function corresponding to either a unit-coverage function or a quality-coverage function.

11. A system for selecting a subset of reviews from a plurality of reviews, the system comprising:
a processor that processes a greedy algorithm to select a subset of reviews that maximizes an increase for a cumulative coverage scoring function; and
a memory that stores the results of the processing.

12. The system of claim 11, wherein the cumulative coverage scoring function is based on a unit-coverage function for a plurality of attributes covered by a plurality of reviews.

13. The system of claim 11, wherein the cumulative coverage scoring function is based on a quality-coverage function for a plurality of attributes covered by a plurality of reviews.

14. The system of claim 11, wherein the cumulative coverage scoring function is based on a soft-group-coverage function for a plurality of attributes covered by a plurality of reviews.

15. The system of claim 11, wherein the greedy algorithm is a t-greedy algorithm, and wherein the cumulative coverage scoring function is based on a group-coverage function for a plurality of attributes covered by a plurality of tuples comprising a plurality of reviews.

16. A computer-readable medium comprising computer readable instructions that when executed by a computer cause the computer to:
receive as input a set of reviews and a first value;
recursively add a review from the set of reviews to a subset of reviews until the subset of reviews is equal in number to the first value, wherein each review added from the set of reviews to the subset of reviews is a review that maximizes a cumulative coverage scoring function pertaining to the subset of reviews; and
return as output the resulting subset of reviews.

17. The computer-readable medium of claim 16, wherein each review added to the subset of reviews is a review having the highest-quality score for at least one attribute from among a plurality of attributes.

18. The computer-readable medium of claim 16, wherein the cumulative coverage scoring function
$$F ( S ) = {Σ}_{a ∈ A} f ( S , a ) ,$$
wherein F(S) is the cumulative coverage scoring function, wherein ƒ(S,a) is a specific coverage scoring function, wherein S is the subset of reviews, wherein a is an attribute from among the plurality of attributes, and wherein A is the plurality of attributes.

19. The computer-readable medium of claim 16, wherein the coverage scoring function ƒ(S,a) for the cumulative coverage scoring F(S) is a function from among the group of functions comprising a unit-coverage function, a soft-group-coverage function, and a group-coverage function.

20. The computer-readable medium of claim 16, wherein the cumulative coverage scoring function is executed using a greedy algorithm or a t-greedy algorithm.
